(19) United States
(12) Patent Application Publication
(10) Pub. No.: US 2025/0125342 A1
(43) Pub. Date: Apr. 17, 2025

(54) NEGATIVE ELECTRODE ACTIVE MATERIAL AND RECHARGEABLE LITHIUM BATTERY INCLUDING SAME

(71) Applicants: SAMSUNG SDI CO., LTD., Yongin-si (KR); POSTECH RESEARCH AND BUSINESS DEVELOPMENT FOUNDATION, Pohang-si (KR)

(72) Inventors: Seyoung OH, Yongin-si (KR); Sang-Min LEE, Pohang-si (KR); Hwijoo LEE, Pohang-si (KR); Ilyoung CHOI, Yongin-si (KR); Deok-Hyun KIM, Yongin-si (KR); Youngugk KIM, Yongin-si (KR)

(21) Appl. No.: 18/731,582

(22) Filed: Jun. 3, 2024

(30) Foreign Application Priority Data
Oct. 11, 2023 (KR) 10-2023-0135277

(51) Int. Cl. H01M 4/36; H01M 4/02; H01M 4/04; H01M 4/48; H01M 4/583; H01M 4/60; H01M 10/0525

(52) U.S. Cl. CPC H01M 4/366; H01M 4/0471; H01M 4/483; H01M 4/583; H01M 4/604; H01M 10/0525; H01M 2004/021; H01M 2004/027

(57) ABSTRACT

A negative electrode active material and a rechargeable lithium battery including the negative electrode active material, the negative electrode active material includes a core including a carbon material; vanadium oxide on a surface of the core; and a fluorine (F)-containing carbon layer on the surface of the core and on a surface of the vanadium oxide.

### CROSS-REFERENCE TO RELATED APPLICATION

This application claims priority to and the benefit of Korean Patent Application No. 10-2023-0135277 filed in the Korean Intellectual Property Office on Oct. 11, 2023, the entire contents of which are incorporated herein by reference.

### BACKGROUND

### 1. Field

Embodiments relate to a negative electrode active material and a rechargeable lithium battery including the same.

### 2. Description of the Related Art

In order to respond to climate change, as automobile fuel efficiency regulations and mandatory introduction of electric vehicles are being globally implemented, the demand for the electric vehicles is gradually increasing.

### SUMMARY

The embodiments may be realized by providing a negative electrode active material including a core including a carbon material; vanadium oxide on a surface of the core; and a fluorine (F)-containing carbon layer on the surface of the core and on a surface of the vanadium oxide.

The F-containing carbon layer may be an amorphous carbon layer including fluorine.

The vanadium oxide may be present in the form of islands discontinuously on the surface of the core.

The vanadium oxide on the surface of the core may have a thickness of about 1 nm to about 150 nm.

The F-containing carbon layer may be present in a form of an island discontinuously on the surface of the core and the vanadium oxide.

A amount of the vanadium oxide may be about 0.1 wt % to about 5 wt %, based on a total weight of the negative electrode active material.

The F-containing carbon layer may be prepared from polyvinylidene fluoride, poly(vinylidene fluoride-co-hexafluoropropylene), polytrifluoroethylene, poly(vinylidene fluoride-co-trifluoroethylene), or a combination thereof.

An amount of the core may be about 90 wt % to about 98 wt %, based on a total weight of the negative electrode active material.

The vanadium oxide may be VO, V₂O₃, VO₂, V₂O₅, or a combination thereof.

The vanadium oxide may be V₂O₅.

The carbon material may be crystalline carbon.

The crystalline carbon may be natural graphite, artificial graphite, or a combination thereof.

The negative electrode active material for a rechargeable lithium battery may be prepared by a process including mixing a carbon material and a vanadium oxide precursor in a solvent to prepare a first mixture; preparing a first heat treatment product by first heat treating the first mixture; mixing the first heat treatment product and a F-containing polymer in a solvent to prepare a second mixture; and subjecting the second mixture to a second heat treatment.

The embodiments may be realized by providing a rechargeable lithium battery including a negative electrode including the negative electrode active material according to an embodiment; a positive electrode; and an electrolyte.

### BRIEF DESCRIPTION OF THE DRAWINGS

Features will be apparent to those of skill in the art by describing in detail exemplary embodiments with reference to the attached drawings in which:

FIG. 1 is a schematic view showing a rechargeable lithium battery according to some embodiments.

FIG. 2 is a graph showing the discharge capacity according to charge and discharge of the battery cells according to Example 1 and Comparative Examples 1 and 2.

FIG. 3 is a graph showing the charge/discharge characteristics of the battery cell according to Example 1.

FIG. 4 is a graph showing the charge/discharge characteristics of the battery cells according to Comparative Example 1.

FIG. 5 is a graph showing high-rate charge/discharge characteristics of battery cells according to Example 1 and Comparative Example 1.

FIG. 6 is an SEM image of the negative electrode surface after charging and discharging in Example 1.

FIG. 7 is an SEM image of the negative electrode surface after charging and discharging of Comparative Example 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present disclosure. The singular expression includes the plural expression unless the context clearly dictates otherwise.

As used herein, “combination thereof” refers to a mixture, a laminate, a composite, a copolymer, an alloy, a blend, a reaction product, and the like of constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

Throughout the specification of the present disclosure, when it is said that a constituent component “includes” a certain component, this means that it does not exclude other components but may further include other components, unless specifically stated to the contrary.

In addition, the terms “about,” “substantially,” etc. used throughout the specification herein are used in the sense of being at or close to that value when manufacturing and material tolerances inherent in the stated meaning are presented and are used to prevent unscrupulous infringers from taking unfair advantage of disclosures in which precise or absolute figures are mentioned so as to aid understanding of the present disclosure.

Throughout this specification, the descriptions of “A or B” and “A and/or B” is non-exclusive, and means “A or B or both.”

“Thickness” may be measured through a picture taken with an optical microscope such as a scanning electron microscope. In addition, “thickness” refers to an average thickness.

As used herein, when a definition is not otherwise provided, the particle diameter may be an average particle diameter. This average particle diameter means the average particle diameter (D50), which means a diameter (D50) of particles having a cumulative volume of 50 volume % in a particle size distribution. If the particle size is spherical, the diameter represents the particle diameter or average particle diameter, and if the particle size is not spherical, the diameter may be the major axis length or the average major axis length. The average particle diameter (D50) may be measured by a method well known to those skilled in the art and may be, for example, measured by a particle size analyzer, or transmission electron microscope, scanning electron microscope, or field emission scanning electron microscopy (FE-SEM). Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, for example, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle size (D50) based on 50% of the particle size distribution in the measuring device can be calculated.

A mixture refers to a solid mixture of active material, binder, and optionally conductive material. For example, the mixture refers to an active material layer. Accordingly, the mixture density may be the density of the active material layer.

A negative electrode active material according to some embodiments may include a core including a carbon-based material, vanadium oxide on the surface of the core, and a fluorine (F)-containing carbon layer on surfaces of the core and the vanadium oxide.

In an implementation, the vanadium oxide may be, e.g., VO, V₂O₃, VO₂, V₂O₅, or a combination thereof. In an implementation, the vanadium oxide may be, e.g., V₂O₅.

In an implementation, the vanadium oxide may be present in the form of islands discontinuously on the surface of the core. In an implementation, the F-containing carbon layer may also be present in the form of an island discontinuously on the surface of the core and the vanadium oxide.

In an implementation, presence in the form of an island means that it is not present to substantially completely cover the surface of the target substrate, but is present discontinuously on the surface of the target substrate, so that a portion of the target substrate or underlying element may be exposed.

In the negative electrode active material according to some embodiments, vanadium oxide may be present on the surface of the core, so that the resistance generated during intercalation and deintercalation of lithium ions may be reduced, thereby improving high-rate charging characteristics. This resistance reduction effect may be achieved more effectively if vanadium oxide is present in island form on the surface of the core.

In an implementation, the F-containing carbon layer may be present on the core and the surface of the vanadium oxide, electrical conductivity may be secured, and as a result, a decrease in electrical conductivity due to the use of vanadium oxide with low electrical conductivity may be prevented.

In an implementation, the negative electrode active material according to some embodiments may include an F-containing carbon layer, and it is possible to sufficiently reduce the resistance that occurs during intercalation and deintercalation of lithium without lowering electrical conductivity due to the use of vanadium oxide. Improved high-rate charging characteristics may be obtained, and deterioration of charge/discharge efficiency and cycle-life characteristics may be maintained.

In an implementation, the vanadium oxide may be present on the surface of the core with a thickness of about 1 nm to about 150 nm. In an implementation, the thickness of the vanadium oxide may be, e.g., about 1 nm to about 100 nm, or about 1 nm to about 50 nm. Maintaining the thickness of vanadium oxide within the above ranges may help ensure that the lithium ion diffusion path becomes shorter, enabling rapid transport, and the specific surface area increases, further increasing a reaction area.

An amount of the vanadium oxide may be, e.g., about 0.1 wt % to about 5 wt %, about 0.1 wt % to about 2 wt %, or about 0.1 wt % to about 1 wt %, based on a total weight of the negative electrode active material. Maintaining the amount of vanadium oxide within the above ranges may help ensure that the resistance reduction effect due to the use of vanadium oxide may be more effectively obtained without deteriorating electrical conductivity.

In an implementation, an amount of the core may be, e.g., about 90 wt % to about 99 wt %, about 95 wt % to about 99 wt %, or about 97 wt % to about 99 wt %, based on a total weight of the negative electrode active material.

In an implementation, the carbon material may be, e.g., crystalline carbon. This crystalline carbon may be an unspecified-shaped, plate-shaped, flake-shaped, spherical, or fibrous, such as natural graphite, artificial graphite, or a combination thereof.

The F-containing carbon layer may be an amorphous carbon layer including F element (e.g., including fluorine).

In an implementation, the amorphous carbon layer including fluorine may be derived or prepared from an F-containing polymer, e.g., polyvinylidene fluoride, poly(vinylidene fluoride-co-hexafluoropropylene), polytrifluoroethylene, poly(vinylidene fluoride-co-trifluoroethylene), or a combination thereof. In an implementation, the amorphous carbon layer including fluorine may be obtained using the F-containing polymer.

In the amorphous carbon layer including fluorine, the amorphous carbon may be soft carbon.

In an implementation, an amount of the F-containing carbon layer may be, e.g., about 0.9 wt % to about 5 wt %, about 0.9 wt % to about 3 wt %, or about 0.9 wt % to about 2 wt %, based on a total weight of the negative electrode active material.

The preparing process of this negative electrode active material is described below.

First, a first mixture may be prepared by mixing a carbon material and a vanadium oxide precursor in a solvent.

In an implementation, the vanadium oxide precursor may first be added and dissolved in a solvent to prepare a precursor solution, and then the carbon material may be added to the precursor solution. The process of adding the precursor to the solvent may be performed at, e.g., about 60° C. to about 120° C., or about 70° C. to about 100° C.

In an implementation, the vanadium oxide precursor may include, e.g., vanadyl acetylacetonate, ammonium metavanadate, vanadium oxide, vanadyl sulfate, vanadium (V) oxytripropoxide), or a combination thereof. The solvent may include, e.g., methanol, ethanol, propanol, other alcohol, water, or a combination thereof.

The carbon material may include, e.g., crystalline carbon, as described above.

In the mixing process, a mixing ratio of the vanadium oxide precursor and the carbon material may be, e.g., about 1:99 to about 10:90, or about 3:97 to about 10:90 by weight. Maintaining the mixing ratio of the carbon material and the vanadium oxide precursor within the above ranges may help ensure that the vanadium oxide is present at an appropriate thickness on the surface of the core.

The mixing process may be performed until the solvent evaporates.

Subsequently, the first mixture may be subjected to first heat treatment to prepare a first heat treatment product.

According to or as a result of the first heat treatment process, the vanadium oxide precursor may be decomposed to form vanadium oxide, and the vanadium oxide may be present on the surface of the carbon material, e.g., at a specific thickness. In an implementation, the vanadium oxide may be present in the form of islands present discontinuously on the surface of the carbon-based material.

The first heat treatment process may be performed at, e.g., about 200° C. to about 500° C. or about 300° C. to about 500° C. The first heat treatment process may be performed for about 1 hour to about 7 hours, e.g., about 1 hour to about 5 hours, or about 1 hour to about 3 hours. The first heat treatment process may be performed under an atmospheric or air atmosphere.

In an implementation, the first heat treatment process may be performed under the above conditions, the vanadium oxide precursor may be properly decomposed, and vanadium oxide may be obtained without impurities.

The first heat treatment product and the F-containing polymer may be mixed in a solvent to prepare a second mixture. In an implementation, the F-containing polymer may be added and dissolved in a solvent to prepare a polymer solution, and the first heat treatment product may be added to the polymer solution. The polymer solution manufacturing process may be carried out at, e.g., about 60° C. to about 120° C., or about 70° C. to about 100° C.

The F-containing polymer may include, e.g., polyvinylidene fluoride, poly(vinylidene fluoride-co-hexafluoropropylene), polytrifluoroethylene, poly(vinylidene fluoride-co-trifluoroethylene), or a combination thereof.

A mixing ratio of the first heat treatment product and the F-containing polymer may be, e.g., about 90:10 to about 99:1, or about 95:5 to about 99:1, by weight.

Maintaining the mixing ratio of the first heat treatment product and the F-containing polymer within the above ranges may help ensure that there is an advantage of having appropriate electrical conductivity.

The mixing process may be performed until the solvent evaporates, e.g., at about 80° C. to about 120° C.

The obtained second mixture may be subjected to a second heat treatment.

According to or as a result of the second heat treatment process, the F-containing polymer may be decomposed and converted to amorphous carbon including fluorine, and an F-containing carbon layer may be formed in the form of an island on the surfaces of the core and the vanadium oxide.

The second heat treatment process may be performed at, e.g., about 400° C. to about 900° C., about 400° C. to about 800° C., or about 500° C. to about 800° C. The second heat treatment process may be performed for, e.g., about 1 hour to about 5 hours, or about 2 hours to about 5 hours.

The second heat-treatment process may be performed under an inert gas atmosphere, e.g., Ar, He, or a combination thereof. The second heat treatment process may be performed while continuously flowing the inert gas during the second heat treatment process.

In an implementation, the second heat treatment process may be performed under the above conditions, and the carbonization process that produces amorphous carbon without impurities may proceed desirably.

In an implementation, a rechargeable lithium battery including negative electrode active material may be subjected to formation charging, and vanadium oxide present on the surface of the core may react with lithium ions and may form lithium vanadium oxide. As a result, in a battery subjected to formation charging, the separated negative electrode active material may include lithium vanadium oxide. The formation of lithium vanadium oxide may be measured using TEM (Transmission electron microscopy).

The lithium vanadium oxide generated during formation charging may be suitable as it may help further improve electrochemical performance.

The formation charging may be performed, e.g., from 0.01 V to 1.5 V at 0.1 C to 0.2 C.

Some embodiments may provide a rechargeable lithium battery including a negative electrode, a positive electrode, and an electrolyte. The negative electrode may include a negative electrode current collector and a negative electrode active material layer on at least one surface of the negative electrode current collector. The negative electrode active material layer includes the negative electrode active material according to the above embodiment. In an implementation, the negative electrode active material may include the negative electrode active material according to the aforementioned embodiment as a first active material and may further include a silicon negative electrode active material as a second active material. A mixing ratio of the first negative electrode active material and the second negative electrode active material may be, e.g., about 99:1 to about 50:50, or about 95:5 to about 80:20.

The silicon active material may include, e.g., Si, a Si—C composite, SiOₓ (0<x<2), a Si-Q alloy (wherein Q is an element selected from an alkali metal, an alkaline earth metal, a Group 13 element, a Group 14 element, a Group 15 element, a Group 16 element, a transition metal, a rare earth element, and a combination thereof, but not Si), or the like, and at least one of these may be mixed with SiO₂. The element Q may include, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

In an implementation, the Si—C composite may be in the form of silicon particles and amorphous carbon coated on the surface of the silicon particles. In an implementation, the silicon-carbon composite may include secondary particles assembled from silicon primary particles and an amorphous carbon coating layer on the surface of the secondary particles. The amorphous carbon may also be between the primary silicon particles, so that, e.g., the primary silicon particles may be coated with amorphous carbon. The silicon-carbon composite may include a core in which silicon particles are dispersed in an amorphous carbon matrix and an amorphous carbon coating layer coating the surface of the core.

The secondary particles may be in the center of the Si—C composite, which may be referred to as the core and a center portion. The amorphous carbon coating layer may be referred to as a shell or an outer portion.

The silicon particles may be nano silicon particles. A particle diameter of the nano silicon particles may be, e.g., about 10 nm to about 1,000 nm, about 20 nm to about 900 nm, about 20 nm to about 800 nm, about 20 nm to about 500 nm, about 20 nm to about 300 nm, or about 20 nm to about 150 nm. Maintaining the average particle diameter of the silicon particles within the above ranges may help ensure that excessive volume expansion (which could otherwise occur during charging and discharging) is suppressed, and disconnection of the conductive path due to particle crushing during charging and discharging may be prevented.

A mixing ratio of the silicon particles and amorphous carbon may be, e.g., about 20:80 to about 70:30 by weight.

In an implementation, the secondary particles or the core may further include crystalline carbon. In an implementation, the silicon-carbon composite may further include the crystalline carbon, the Si—C composite may include secondary particles in which silicon primary particles and crystalline carbon are agglomerated, and an amorphous carbon coating layer on the surface of the secondary particles.

In an implementation, Si—C may include silicon particles, crystalline carbon, and amorphous carbon, and an amount of the amorphous carbon may be about 30 wt % to about 70 wt % based on a total weight of the total Si—C composite, and an amount of the crystalline carbon may be about 1 wt % to about 20 wt %, based on a total weight of the total Si—C composite. An amount of silicon particles may be about 20 wt % to about 69 wt %, or about 30 wt % to about 60 wt %, based on a total weight of the total Si—C composite.

In an implementation, the particle size of the Si—C composite may be suitably adjusted.

In an implementation, the amorphous carbon may be present surrounding the secondary surface, its thickness may be adjusted appropriately, e.g., at a thickness of about 5 nm to about 100 nm.

In the negative electrode active material layer, an amount of the negative electrode active material may be about 95 to about 99 wt %, based on a total weight of the negative electrode active material layer.

In an implementation, the negative electrode active material layer may also include a binder and may optionally further include a conductive material. An amount of the binder in the negative electrode active material layer may be, e.g., about 1 to about 5 wt %, based on a total weight of the negative electrode active material layer. In an implementation, the conductive material may be further included, and the negative electrode active material layer may include about 90 to about 98 wt % of the negative electrode active material, about 1 to about 5 wt % of the binder, and about 1 to about 5 wt % of the conductive material.

The binder may facilitate attachment of the negative electrode active material particles to each other and also to facilitate attachment of the negative electrode active material to the current collector. The binder may be, e.g., a non-aqueous binder, an aqueous binder, or a combination thereof.

The non-aqueous binder may include, e.g., an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may include, e.g., an acrylated styrene-butadiene rubber (SRB), an acrylated styrene-butadiene rubber (ABR), an acrylonitrile-butadiene rubber, an acrylic rubber, butyl rubber, a fluoro rubber, an ethylene oxide-containing polymer, polyvinylpyrrolidone, polypropylene, polyepichlorohydrin, polyphosphazene, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

A cellulose compound may be used as the negative electrode binder, or a mixture of the cellulose compound and the aqueous binder may be used. The cellulose compound may include, e.g., carboxymethyl cellulose, hydroxypropylmethyl cellulose, methyl cellulose, or an alkali metal salt thereof. The alkali metal may be, e.g., Na, K, or Li. The cellulose compound may impart viscosity, and thus it may be called a thickener, and it may also act as a binder, and thus it may also be called a binder. An amount of the cellulose compound may be appropriately adjusted, e.g., may be about 0.1 parts by weight to about 3 parts by weight, based on 100 parts by weight of the negative electrode active material.

The conductive material may impart conductivity to the electrode, and a suitable material that does not cause chemical change in the battery to be configured and that is an electron conductive material may be used. Examples of the conductive material may include a carbon material such as natural graphite, artificial graphite, carbon black, acetylene black, ketjen black, channel black, furnace black, lamp black, thermal black, a carbon fiber, and the like; a metal material of a metal powder or a metal fiber including copper, nickel, aluminum, silver, and the like; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal, or a combination thereof.

The positive electrode may include a positive electrode current collector and a positive electrode active material layer on the positive electrode current collector. The positive electrode active material may include lithiated intercalation compounds that reversibly intercalate and deintercalate lithium ions. In an implementation, a composite oxide of cobalt, manganese, nickel, or a combination thereof, and lithium may be used. In an implementation, a compound represented by any one of the following chemical formulas may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}O_{2-c1}D¹_{c1} (0.90≤a≤1.8, 0≤b≤0.5, 0c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}Co_{b}X_{c}D¹_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α≤2); LiₐNi_{1-b-c}Co_{b}X_{c}O_{2-α}T₂ (0.90≤a≤1.8, 0≤b≤0.5, 0≤c≤0.5, 0<α≤2); LiₐNi_{1-b-c}Mn_{b}X_{c}D¹_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α≤2); LiₐNi_{1-b-c}Mn_{b}X_{c}O_{2-α}T₂ (0.90≤a≤1.8, 0≤b≤0.5, 0≤c≤0.5, 0<α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulas, A may be, e.g., Ni, Co, Mn, or a combination thereof; X may be, e.g., Al, Ni, Co, Mn, Cr, Fe, Mg, Sr, V, a rare earth element, or a combination thereof, D¹ may be, e.g., O, F, S, P, or a combination thereof, E is Co, Mn, or a combination thereof, T may be, e.g., F, S, P, or a combination thereof, G may be, e.g., Al, Cr, Mn, Fe, Mg, La, Ce, Sr, V, or a combination thereof, Q may be, e.g., Ti, Mo, Mn, or a combination thereof, Z may be, e.g., Cr, V, Fe, Sc, Y, or a combination thereof, J may be, e.g., V, Cr, Mn, Co, Ni, Cu, or a combination thereof, and L¹ may be, e.g., Mn, Al, or a combination thereof.

The compounds may have a coating layer on the surface, or may be mixed with another compound having a coating layer. The coating layer may include a coating element compound, e.g., an oxide of a coating element, a hydroxide of a coating element, an oxyhydroxide of a coating element, an oxycarbonate of a coating element, or a hydroxy carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound. In an implementation, the method may include a suitable coating method (e.g., spray coating, dipping, or the like).

In the positive electrode active material layer, an amount of the positive electrode active material may be about 90 to about 98 wt %, based on a total weight of the positive electrode active material layer.

The positive electrode active material layer may also include, e.g., a binder or a conductive material. An amount of each of the binder and the conductive material may be, e.g., about 1 to about 5 wt %, based on a total weight of the positive electrode active material layer.

The binder may facilitate attachment of the positive electrode active material particles to each other and may also facilitate attachment of the positive electrode active material to the current collector. Examples thereof may include polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

The conductive material may impart conductivity to the electrode, and a suitable material that does not cause chemical change in the battery to be configured and that is an electron conductive material may be used. Examples of the conductive material may include a carbon material such as natural graphite, artificial graphite, carbon black, acetylene black, Ketjen black, a carbon fiber, and the like; a metal material of a metal powder or a metal fiber including copper, nickel, aluminum, silver, and the like; a conductive polymer such as a polyphenylene derivative; or a mixture thereof.

The current collector may include, e.g., Al.

The negative and positive electrodes may be manufactured by mixing an active material, a conductive material, and a binder in a solvent to prepare an active material composition and coating this composition on a current collector. The solvent may include, e.g., N-methyl pyrrolidone or the like. In an implementation, an aqueous binder may be used for the negative electrode, and water may be used as the solvent for preparing the negative electrode active material composition.

The electrolyte may include a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol, or aprotic solvent.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethyl acetate, methylpropionate, ethylpropionate, ν-butyrolactone, decanolide, valerolactone, mevalonolactone, caprolactone, or the like. The ether solvent may include dibutyl ether, tetraglyme, diglyme, dimethoxyethane, 2-methyltetrahydrofuran, 2,5-dimethyltetrahydrofuran, tetrahydrofuran, or the like. The ketone solvent may include cyclohexanone, or the like. The alcohol solvent may include ethanol, isopropyl alcohol, or the like. The aprotic solvent may include nitriles such as R—CN (where R is a C2 to C20 linear, branched, or cyclic hydrocarbon, a double bond, may include an aromatic ring, or an ether bond), amides such as dimethylformamide, dioxolanes such as 1,3-dioxolane, 1,4-dioxolane, sulfolanes, or the like.

The non-aqueous organic solvents may be used alone or in combination with one or more, and the mixing ratio (if used in combination with one or more) may be appropriately adjusted according to the desired battery performance.

In an implementation, the non-aqueous organic solvent may be mixed and used, and a mixed solvent of a cyclic carbonate and a chain carbonate, a mixed solvent of a cyclic carbonate and a propionate solvent, or a mixed solvent of a cyclic carbonate, a chain carbonate, and a propionate solvent may be used. The propionate solvent may include, e.g., methyl propionate, ethyl propionate, propyl propionate, or a combination thereof.

In an implementation, the cyclic carbonate and the chain carbonate or the cyclic carbonate and the propionate solvent may be mixed, e.g., in a volume ratio of about 1:1 to about 1:9, and thus performance of an electrolyte may be improved. In an implementation, the cyclic carbonate, the chain carbonate, and the propionate solvent may be mixed, e.g., in a volume ratio of about 1:1:1 to about 3:3:4. The mixing ratios of the solvents may be appropriately adjusted according to desired properties.

In an implementation, the non-aqueous organic solvent of the present disclosure may further include an aromatic hydrocarbon organic solvent in addition to the carbonate solvent. The carbonate solvent and the aromatic hydrocarbon organic solvent may be mixed in a volume ratio of about 1:1 to about 30:1.

The aromatic hydrocarbon organic solvent may be an aromatic hydrocarbon-based compound of Chemical Formula 1.

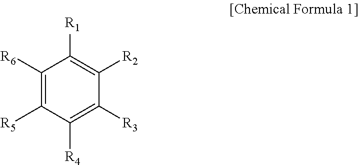

In Chemical Formula 1, R₁ to R₆ may each independently be or include, e.g., hydrogen, a halogen, a C1 to C10 alkyl group, a haloalkyl group, or a combination thereof.

Examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive, e.g., vinylethyl carbonate, vinylene carbonate, or an ethylene carbonate-based compound of Chemical Formula 2, in order to improve a cycle-life of a battery.

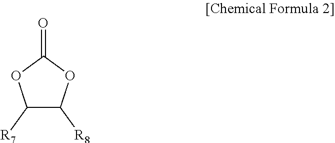

In Chemical Formula 2, R₇ and R₈ may each independently be or include, e.g., hydrogen, a halogen, a cyano group (CN), a nitro group (NO₂), or a fluorinated C1 to C5 alkyl group. In an implementation, at least one of R₇ and R₈ may be or may include, e.g., a halogen, a cyano group (CN), a nitro group (NO₂), or a fluorinated C1 to C5 alkyl group, and R₇ and R₈ may not both be hydrogen.

Examples of the ethylene carbonate compound may include difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving a cycle-life may be used within an appropriate range.

The lithium salt dissolved in an organic solvent may supply a battery with lithium ions, may basically operate the rechargeable lithium battery, and may help improve transportation of the lithium ions between positive and negative electrodes. Examples of the lithium salt may include LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), in which x and y are natural numbers, e.g., integers of 1 to 20, lithium difluoro(bisoxolato) phosphate, LiCl, LiI, LiB(C₂O₄)₂ (lithium bis(oxalato) borate: LiBOB), and lithium difluoro(oxalate) borate (LiDFOB), as a supporting electrolytic salt. A concentration of the lithium salt may range from about 0.1 to about 2.0 M. Maintaining the concentration of the lithium salt at the above concentration range may help ensure that an electrolyte may have excellent performance and lithium ion mobility due to optimal electrolyte conductivity and viscosity.

The rechargeable lithium battery may further include a separator between the negative electrode and the positive electrode, depending on a kind of the battery. Examples of a separator material may include polyethylene, polypropylene, polyvinylidene fluoride, and multi-layers having two or more layers thereof such as a polyethylene/polypropylene double-layered separator, a polyethylene/polypropylene/polyethylene triple-layered separator, and a polypropylene/polyethylene/polypropylene triple-layered separator.

The separator may include the layer as a substrate and may further include a coating layer on at least one surface of the layer.

The coating layer may include ceramic. The ceramic may include, e.g., SiO₂, Al₂O₃, Al(OH)₃, AlO(OH), TiO₂, BaTiO₂, ZnO₂, Mg(OH)₂, MgO, Ti(OH)₄, ZrO₂, aluminum nitride, silicon carbide, boron nitride, or a combination thereof.

The coating layer may be a functional layer capable of adding additional functions. This functional layer may be, e.g., a heat resistant layer or an adhesive layer. The heat resistant layer may include a heat resistant resin and optionally a filler. The adhesive layer may include an adhesive resin and optionally a filler. The filler may be an organic filler, an inorganic filler, or a combination thereof. The heat resistant resin, adhesive resin, and filler may be a suitable material that can be used in separators.

Rechargeable lithium batteries may be classified into, e.g., lithium ion batteries, lithium ion polymer batteries, or lithium polymer batteries, depending on the type of separator and electrolyte used, may be classified into cylindrical, prismatic, coin, pouch, etc. depending on their shape, and may be classified into bulk type and thin film type depending on the size.

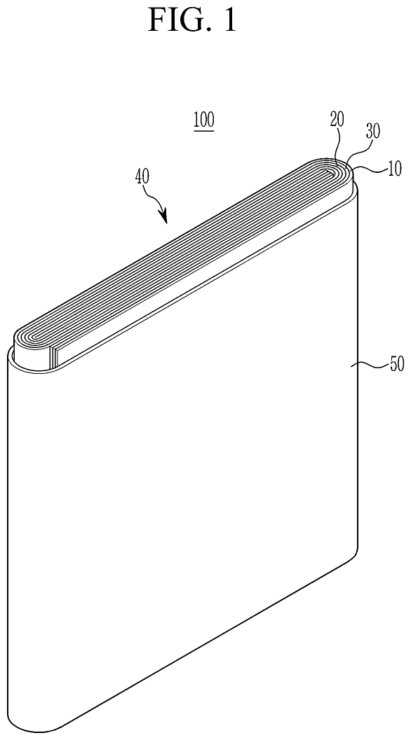

FIG. 1 is an exploded perspective view of a rechargeable lithium battery according to some example embodiments. As illustrated in FIG. 1, the rechargeable lithium battery according to some example embodiments may be a prismatic battery, or may include variously-shaped batteries such as a cylindrical battery, a pouch battery, or the like.

Referring to FIG. 1, the rechargeable lithium battery 100 according to an embodiment may include an electrode assembly 40 manufactured by winding a separator 30 between a positive electrode 10 and a negative electrode 20 and a case 50 housing the electrode assembly 40. An electrolyte may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

A vanadyl acetylacetonate solution was prepared by dissolving vanadyl acetylacetonate in 40 ml of ethanol at 90° C.

To the vanadyl acetylacetonate solution, artificial graphite was added and then, stirred, until the solvent was evaporated, to prepare a first mixture. The vanadyl acetylacetonate and the artificial graphite were mixed in a weight ratio of 3:97.

Subsequently, the first mixture was primarily heat-treated at 400° C. under an air atmosphere for 3 hours to prepare a first heat treatment product in which vanadium oxide was located in the form of an island with an average thickness of 50 nm on the artificial graphite surface.

A polymer solution was prepared by dissolving polyvinylidene fluoride in an N-methyl pyrrolidone solvent at 70° C.

The first heat treatment product was added to the polymer solution and then, stirred at 100° C., until the solvent was evaporated, to prepare a second mixture. The polyvinylidene fluoride and the first heat treatment product were mixed in a weight ratio of 1:99.

The second mixture was secondarily heat-treated at 500° C. under an Ar atmosphere for 4 hours. During the second heat treatment, Ar gas was continuously flowed. The obtained second heat treatment product was pulverized in a mortar and filtered through a m sieve to prepare negative electrode active material as fine powder.

The negative electrode active material included a core of the artificial graphite, V₂O₅ located in the form of an island on the surface of the artificial graphite core, and an F-containing amorphous carbon layer (a soft carbon layer) in the form of an island on the core surface and the V₂O₅ surface.

An amount of the artificial graphite core was 98 wt %, an amount of the V₂O₅ was 1 wt %, and an amount of the F-containing amorphous carbon layer was 1 wt %, based on a total weight of the negative electrode active material, and a thickness of the V₂O₅ was 20 nm to 50 nm.

95 wt % of the negative electrode active material and 5 wt % of a polyvinylidene fluoride binder were mixed in an N-methyl pyrrolidone solvent to prepare negative electrode active material layer slurry.

The negative electrode active material layer slurry was coated on a copper foil current collector and then, dried and pressed to manufacture a negative electrode. The negative electrode had a loading level of 6.5 mg/cm² and active mass density of 1.5 g/cc.

The negative electrode was used with a lithium metal counter electrode and an electrolyte to manufacture a coin-type half-cell. The electrolyte was a 1 M LiPF₆ solution in ethylene carbonate and dimethyl carbonate (in a volume ratio of 3:7).

### Example 2

A negative electrode active material was prepared in the same manner as in Example 1 except that the weight ratio of vanadyl acetonate and artificial graphite was 5:95.

The prepared negative electrode active material included a core of the artificial graphite, V₂O₅ located in the form of an island on the surface of the artificial graphite core, and an F-containing amorphous carbon layer (a soft carbon layer) located in the form of an island on the artificial graphite core surface and the V₂O₅ surface. An amount of the artificial graphite core was 97 wt %, an amount of the V₂O₅ was 2 wt %, and an amount of the F-containing amorphous carbon layer was 1 wt %, based on a total weight of the negative electrode active material, and the V₂O₅ had a thickness of 30 nm to 60 nm.

The negative electrode active material was used in the same manner as in Example 1 to manufacture a negative electrode.

The negative electrode was used in the same manner as in Example 1 to manufacture a half-cell.

### Example 3

A negative electrode active material was prepared in the same manner as in Example 1 except that the weight ratio of vanadyl acetonate and artificial graphite was 10:90.

The prepared negative electrode active material included a core of the artificial graphite, V₂O₅ located in the form of an island on the surface of the artificial graphite core, and an F-containing amorphous carbon layer (a soft carbon layer) on the core surface and the V₂O₅ surface. An amount of the artificial graphite core was 96 wt %, an amount of the V₂O₅ was 3 wt %, and an amount of the F-containing amorphous carbon layer was 1 wt %, based on a total weight of the negative electrode active material, and the V₂O₅ had a thickness of 50 to 100 nm.

The negative electrode active material was used in the same manner as in Example 1 to manufacture a negative electrode.

The negative electrode was used in the same manner as in Example 1 to manufacture a half-cell.

### Comparative Example 1

Polyvinylidene fluoride was added to an N-methyl pyrrolidone solvent at 70° C. and dissolved therein to prepare a polymer solution.

Subsequently, artificial graphite was added to the polymer solution and then, stirred at 100° C., until the solvent was evaporated, to prepare a mixture. The polyvinylidene fluoride and the artificial graphite were mixed in a weight ratio of 1:99.

The mixture was heat-treated at 500° C. under an Ar atmosphere for 4 hours. During the heat treatment, Ar gas was continuously flowed. The obtained heat treatment product was pulverized in a mortar and filtered through a 45 μm sieve to prepare a negative electrode active material as fine powder.

The prepared negative electrode active material included an artificial graphite core and an F-containing amorphous carbon layer (a soft carbon layer) located in the form of an island on the surface of the artificial graphite core. An amount of the artificial graphite core was 99 wt %, based on a total weight of the negative electrode active material.

The negative electrode active material was used in the same manners in Example 1 to manufacture a negative electrode.

The negative electrode was used in the same manner as in Example 1 to manufacture a half-cell.

### Comparative Example 2

Vanadyl acetylacetonate was added to 40 ml of ethanol at 90° C. and dissolved therein to prepare a vanadyl acetylacetonate solution.

To the vanadyl acetylacetonate solution, artificial graphite was added and then, stirred, until the solvent was evaporated, to prepare a first mixture. The vanadyl acetonate and the artificial graphite were mixed in a weight ratio of 3:97.

Subsequently, the first mixture was primarily heat-treated at 400° C. for 3 hours under an air atmosphere to obtain a negative electrode active material in which vanadium oxide was positioned in the form of an island with an average thickness of 50 nm on the artificial graphite surface.

### Comparative Example 3

95 wt % of an artificial graphite negative electrode active material and 5 wt % of a polyvinylidene fluoride binder were mixed in an N-methyl pyrrolidone solvent to prepare negative electrode active material layer slurry.

The negative electrode active material layer slurry was used in the same manner as in Example 1 to manufacture a negative electrode.

The negative electrode was used in the same manner as in Example 1 to manufacture a half-cell.

### Comparative Example 4

A negative electrode active material was prepared in the same manner as in Example 1 except that cobalt(II) acetate tetrahydrate was used instead of the vanadyl acetonate.

The prepared negative electrode active material included an artificial graphite core, cobalt oxide located in the form of an island on the surface of the artificial graphite core, and an F-containing amorphous carbon layer (a soft carbon layer) on the core surface and the cobalt oxide surface. An amount of the artificial graphite core was 98 wt %, an amount of the cobalt oxide was 1 wt %, and an amount of the F-containing amorphous carbon layer was 1 wt %, based on a total weight of the negative electrode active material, and the cobalt oxide had a thickness of 20 to 200 nm.

The negative electrode active material was used in the same manner as in Example 1 to manufacture a negative electrode.

The negative electrode was used in the same manner as in Example 1 to manufacture a half-cell.

### Comparative Example 5

Pitch carbon was added to a tetrahydrofuran (THF) solvent at 50° C. and dissolved therein to prepare a solution.

Except for using the polymer solution, a negative electrode active material was prepared in the same manner as in Example 1.

The prepared negative electrode active material included an artificial graphite core, V₂O₅ located in the form of an island on the surface of the artificial graphite core, and an amorphous carbon layer (a soft carbon layer) located in the form of an island on the core surface and the V₂O₅ surface. An amount of the artificial graphite core was 98 wt %, an amount of the V₂O₅ was 1 wt %, and an amount of the amorphous carbon was 1 wt %, based on a total weight of the negative electrode active material, and the V₂O₅ had a thickness of 20 nm to 50 nm.

The negative electrode active material was used in the same manner as in Example 1 to manufacture a negative electrode.

The negative electrode was used in the same manner as in Example 1 to manufacture a half-cell.

### Experimental Example 1) Formation Charging

The half-cell of Example 1 was charged to 1.5 V at 0.1 C as formation charging. Subsequently, after separating the negative electrode active material from the half-cell, when analyzed through TEM (transmission electron microscopy), the negative electrode active material of Example 1 exhibited that lithium vanadium oxide was present.

### Experimental Example 2) Evaluation of Cycle-life Characteristics

The half-cells of Examples 1 to 3 and the Comparative Examples 1 to 4 were charged and discharged at 0.1 C and charged and discharged at 0.2 C within a potential region of 0.01 V to 1.5 V vs. Li/Li as formation charging/discharging. After the formation charging/discharging of the cells, the cells were charged at a constant current of 6 C.

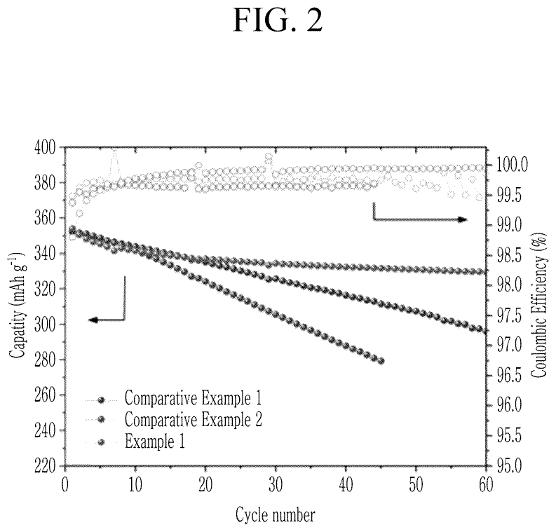

Subsequently, the charged cells were charged to 0.01 C at a constant voltage of 0.01 V and discharged at a constant current of 0.2 C, which was repeated 60 times. The cells were measured with respect to charge capacity and discharge capacity at each cycle. Among the results, the discharge capacity of the cells of Example 1 and Comparative Exampled 1 and 2 is shown in FIG. 2. A ratio of the discharge capacity to the charge capacity (discharge capacity/charge capacity) at each cycle was calculated to obtain coulombic efficiency. The results are shown in FIG. 2.

As shown in FIG. 2, the cell using the negative electrode active material of Example 1, compared with the cells using the negative electrode active materials of Comparative Examples 1 and 2, exhibited high discharge capacity and thus excellent cycle-life characteristics, compared with the cells of Comparative Examples 1 and 2. Comparative Example 2 was charged and discharged 45 times, and exhibited extremely deteriorated discharge capacity to about 78% of the initial capacity.

In addition, the cell using the negative electrode active material of Example 1 exhibited excellent coulombic efficiency at each cycle, compared with the cells of Comparative Examples 1 and 2.

### Experimental Example 3) Evaluation of Charge and Discharge Characteristics

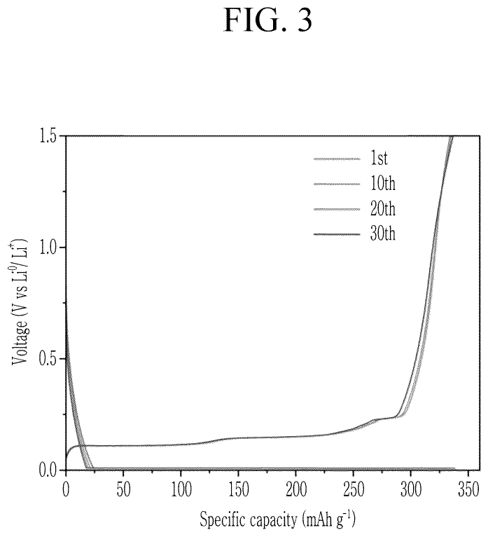

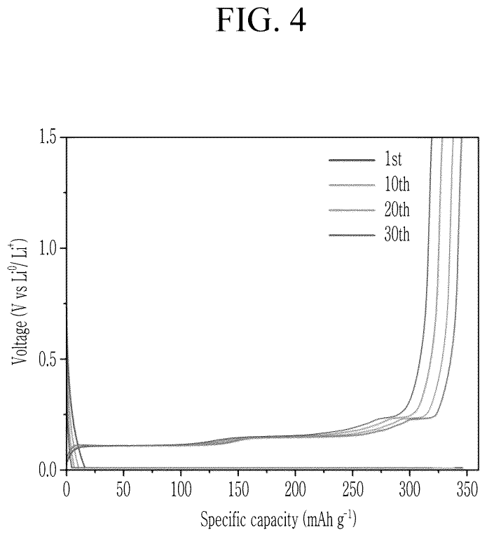

The cells of Example 1 and Comparative Example 1 were charged and discharged 30 times under the following conditions. The 1^{st}, 10^{th}, 20^{th}, and 30^{th} charge/discharge characteristics are respectively shown in FIGS. 3 and 4.

As shown in FIG. 3, the cell using the negative electrode active material of Example 1 maintained charge/discharge characteristics well after the 30^{th} charge and discharge. On the contrary, as shown in FIG. 4, the cell using the negative electrode active material of Comparative Example 1 exhibited that the charge/discharge characteristics started to be deteriorated from the 10^{th} charge and discharge.

Charge: 6 C, to 0.01 V, cut-off: 0.01 C

Discharge: 0.2 C, cut-off: 1.5 V

Experimental Example 4) Evaluation of High-rate Charging Characteristics

The cells of Example 1 and Comparative Example 1 were charged to 0.01 V at a constant current of 0.1 C and to 0.01 C at a constant voltage of 0.01 V and then, discharged at a constant current of 0.2 C. Subsequently, the charge and discharge were performed once at each C-rate by changing the constant current charge rate to 0.2 C, 0.5 C, 1 C, 2 C, 3 C, and 6 C.

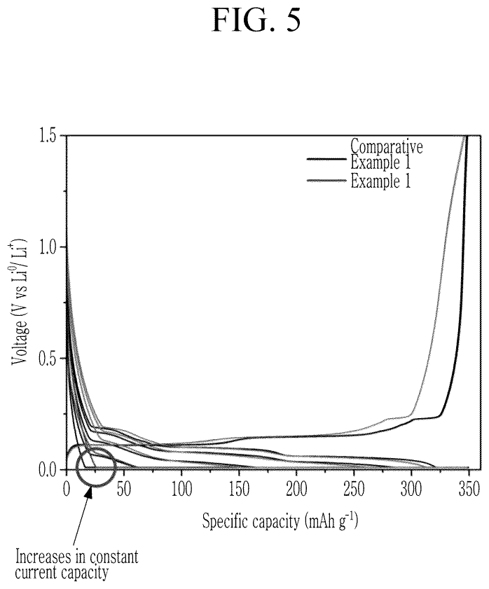

The cells were measured with respect to charge/discharge characteristics at each C-rate, and the results are shown in FIG. 5. As marked as a circle in FIG. 5, the cell of Example 1 exhibited improved constant current capacity at 6 C, which was superior to the cells of the Comparative Examples.

### Experimental Example 5) SEM Image Evaluation During High-Rate Charging and Discharging

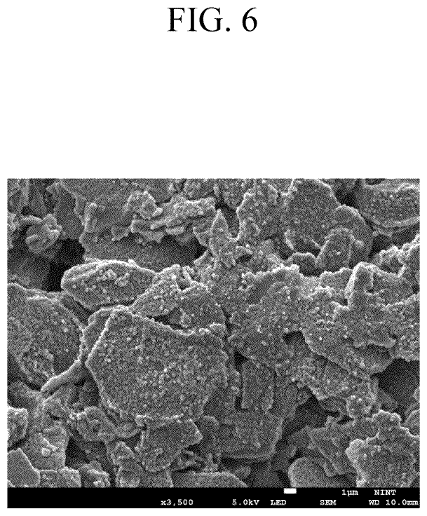

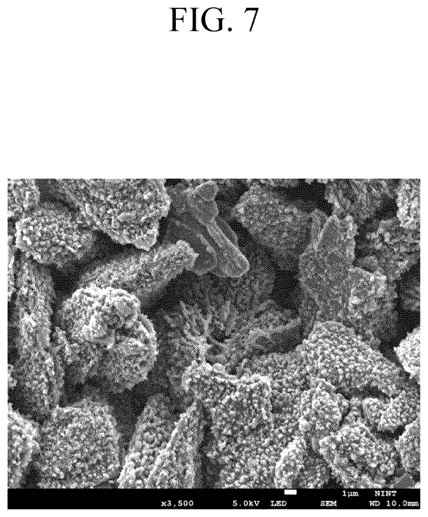

The cells of Example 1 and Comparative Example 3 were repeatedly charged to 6 C at 0.01 V and cut off at 0.01 C and then, discharged at 0.2 C and cut off at 1.5 V 50 times. When the cells were completed with the charge and discharge, each negative electrode was separated therefrom to take an SEM image. The result of Example 1 is shown in FIG. 6, and the result of Comparative Example 3 is shown in FIG. 7.

As shown in FIGS. 6 and 7, lithium precipitation of the cell of Example 1 was suppressed, as compared with that of Comparative Example 3.

By way of summation and review, in order to increase a driving distance of the electric vehicles, research has been mainly conducted to improve energy density of rechargeable lithium batteries. In order to widely spread the electric vehicles, charging time may be reduced. Rechargeable lithium batteries capable of rapid charging have been considered.

One or more embodiments may provide a negative electrode active material with improved rapid charging and cycle-life characteristics.

The negative electrode active material according to some embodiments may exhibit excellent charge and discharge efficiency and cycle-life characteristics while exhibiting improved high-rate charging characteristics.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative electrode active material, comprising:
a core including a carbon material;
vanadium oxide on a surface of the core; and
a fluorine (F)-containing carbon layer on the surface of the core and on a surface of the vanadium oxide.

2. The negative electrode active material of claim 1, wherein the F-containing carbon layer is an amorphous carbon layer including fluorine.

3. The negative electrode active material of claim 1, wherein the vanadium oxide is present in the form of islands discontinuously on the surface of the core.

4. The negative electrode active material of claim 1, wherein the vanadium oxide on the surface of the core has a thickness of about 1 nm to about 150 nm.

5. The negative electrode active material of claim 1, wherein the F-containing carbon layer is present in a form of an island discontinuously on the surface of the core and the vanadium oxide.

6. The negative electrode active material of claim 1, wherein an amount of the vanadium oxide is about 0.1 wt % to about 5 wt %, based on a total weight of the negative electrode active material.

7. The negative electrode active material of claim 1, wherein the F-containing carbon layer is prepared from polyvinylidene fluoride, poly(vinylidene fluoride-co-hexafluoropropylene), polytrifluoroethylene, poly(vinylidene fluoride-co-trifluoroethylene), or a combination thereof.

8. The negative electrode active material of claim 1, wherein an amount of the core is about 90 wt % to about 98 wt %, based on a total weight of the negative electrode active material.

9. The negative electrode active material of claim 1, wherein the vanadium oxide is VO, V₂O₃, VO₂, V₂O₅, or a combination thereof.

10. The negative electrode active material of claim 1, wherein the vanadium oxide is V₂O₅.

11. The negative electrode active material of claim 1, wherein the carbon material is crystalline carbon.

12. The negative electrode active material of claim 11, wherein the crystalline carbon is natural graphite, artificial graphite, or a combination thereof.

13. The negative electrode active material of claim 1, wherein the negative electrode active material for a rechargeable lithium battery is prepared by a process including:
mixing a carbon material and a vanadium oxide precursor in a solvent to prepare a first mixture;
preparing a first heat treatment product by first heat treating the first mixture;
mixing the first heat treatment product and a F-containing polymer in a solvent to prepare a second mixture; and
subjecting the second mixture to a second heat treatment.

14. A rechargeable lithium battery, comprising:
a negative electrode including the negative electrode active material as claimed in claim 1;
a positive electrode; and
an electrolyte.
